(19) United States
(12) Patent Application Publication
(10) Pub. No.: US 2007/0045992 A1
(43) Pub. Date: Mar. 1, 2007

(54) Golf cart bag

(76) Inventor: Vary Pen Jackson, Seattle, WA (US)

Correspondence Address: Delbert J. Barnard, P.O. Box 58888, Seattle, WA, 98138-1888, US

(21) Appl. No.: 11/212,426

(22) Filed: Aug. 27, 2005

(51) Int. Cl. B62B 3/00; B62B 9/00; B62B 11/00; B65D 65/02; B65D 85/00

(52) U.S. Cl. 280/655; 280/47.371; 150/159

(57) ABSTRACT

A bag (10) has a bottom (20), for sides (12, 14, 16, 18) and an open top (22). The bottom is given form and some stiffness by a foam plastic pad (38) that is placed within a pocket (36) formed in the bottom (20). At the top of the bag (10), a drawstring (DS) extends through grommets (50). The drawstring (DS) is used to gather and close the upper end of the bag (10) after a folded golf cart has been placed into the bag (10) with its wheels sitting on the bottom (20). The bag (10) is made from a water-resistant, washable nylon material. The material water-resistant and machine washable. The bag (10) may be made from a single color or a combination of colors.

### TECHNICAL FIELD

This invention relates to a cover for a folded golf cart for protecting a carrying space in a vehicle (e.g. trunk) from becoming dirty from dirt on the golf cart, acquired during its use. More particularly, the invention relates to the provision of a golf cart cover in the form of a bag that is attractive, yet rugged, water-resistant, washable, easy to install, easy to remove, and easy to store without taking up much space.

### BACKGROUND OF THE INVENTION

In the patent literature, it has been proposed to provide golf bags with waterproof covers. See, for example, the following United States patents: U.S. Pat. No. 2,907,364, granted Oct. 6, 1959, to Frank N. Trenery; U.S. Pat. No. 4,474,388, granted Oct. 2, 1984, to Loren E. Wagner; U.S. Pat. No. 5,265,894, granted Nov. 30, 1993, to Steven B. Dunn; U.S. Pat. No. 5,274,901, granted Jan. 4, 1994, to Ralph S. Sanders; and U.S. Pat. No. 6,186,522, granted Feb. 13, 2001, Raymond P. Weis.

U.S. Pat. No. 5,632,496, granted May 27, 1997, to Alan F. Nelson, discloses an attachment for a golf bag which includes a compartment adapted to receive a folded golf cart. The wheels are removed from the folded frame of the golf cart. Then, the frame and wheels are separately placed into the compartment and the compartment is closed by a zipper that extends lengthwise of the compartment.

There is a need for an easy-to-install cover for a dirty golf cart so that such golf cart can be carried in a trunk or other space in a vehicle without it making that space dirty. It is an object of the present invention to provide a golf cart cover in the form of a bag made from a colorful, rugged, water-resistant and washable material, such as nylon. It is another object to the invention to provide such a cover that is easy to install and remove from the golf cart, easy to wash, and easy to fold into a small dimension so that it does not take up much storage space when it is not being used.

### BRIEF SUMMARY OF THE INVENTION

The golf cart cover of the present invention is a bag adapted to receive the golf cart when it is in a folded condition with its wheels moved together at its bottom. The frame is collapsed and extends upwardly from the wheels to a top. The bag is basically characterized by a bottom and a side wall. The bottom has a periphery and the side wall has a lower edge that is connected to and extends around the periphery of the bottom. The side wall extends upwardly from the bottom to an open top that is adapted to be above the top of the collapsed frame of a folded golf cart that has been placed into the bag. The side wall is made from a supple fabric member. The bottom of the bag has a supple fabric upper portion and a supple lower portion which meet and are connected together at the periphery at the bottom. A foam plastic insert is positioned between the upper and lower fabric portions of the bottom. This insert gives the bottom a form and some stiffness. A tie gathers the bag together and closes the bag above the top of the frame. The tie creates pleats in an upper portion of the supple side wall and positions the side wall closely adjacent the collapsed frame. As a result, a person wishing to lift and carry the bag with a golf cart inside it need merely grasp the bag and the frame where the bag closely surrounds the frame, making a separate handle unnecessary.

In the preferred embodiment, the supple fabric upper portion of the bottom includes a first part and a second part. The first part overlaps the second part and forms a flap for an opening through which the foam plastic insert can be inserted and removed. Preferably, hook and eye fasteners, e.g. Velcro®, are provided in the region of the overlap for connecting the two parts of the upper portion of the bottom together when the foam plastic insert is inside the bottom, between the upper and lower fabric parts of the bottom.

It is an object of the invention to provide a bag that is constructed from a thin nylon fabric, or some other fabric that is also rugged, water-resistant and washable.

It is another object of the invention to provide a cover or bag for a folded golf cart that is constructed from a single color or multiple colors, and has an attractive appearance.

### BRIEF DESCRIPTION OF THE SEVERAL VIEWS OF THE DRAWINGS

Like reference numerals are used to designate like parts throughout the several views of the drawing, and:

FIG. 1 is a pictorial view of an embodiment of the invention on a supporting surface with its side wall collapsed onto the periphery of its bottom, such view showing the wheels of a folded golf cart sitting on the bottom within the confines of the side wall;

FIG. 2 is a view like FIG. 1 showing the side wall of the bag moved part way upwardly along the folded frame of the golf cart;

FIG. 3 is a view like FIG. 2 but showing the side wall moved above the top of the folded frame and a tie in the form of a drawstring used to gather and secure the top of the bag and create pleats in the upper portion of the bag outwardly of the folded frame;

FIG. 4 is a fragmentary pictorial view of lower portions of the bag and the golf cart, showing a pocket formed in the bottom, a foam insert in the pocket, and a closure flap that is partially open;

FIG. 5 is a pictorial view of the bag by itself, showing that the side wall of the bag may be formed from four generally rectangular panels that are secured together at their edges;

FIG. 6 is a flat view of one of two of the four sides of the bag;

FIG. 7 is a flat view of one of the remaining two sides of the bag;

FIG. 8 is a flat view of a lower panel portion of the bottom;

FIG. 9 is a flat view of an upper portion of the bottom;

FIG. 10 is a flat view of a flap part of the upper portion of the bottom;

FIG. 11 is a flat view of the foam insert for the bottom;

FIG. 12 is a flat view of one of two pockets that may be provided on the outside of the bag, for receiving golf shoes;

FIG. 13 is a fragmentary sectional view showing a pocket formed in the bottom;

FIG. 14 is an elevational view of the foam plastic insert for the pocket; and

FIG. 15 is a view like FIG. 13, showing the foam plastic insert in the pocket.

### BEST MODE FOR CARRYING OUT THE INVENTION

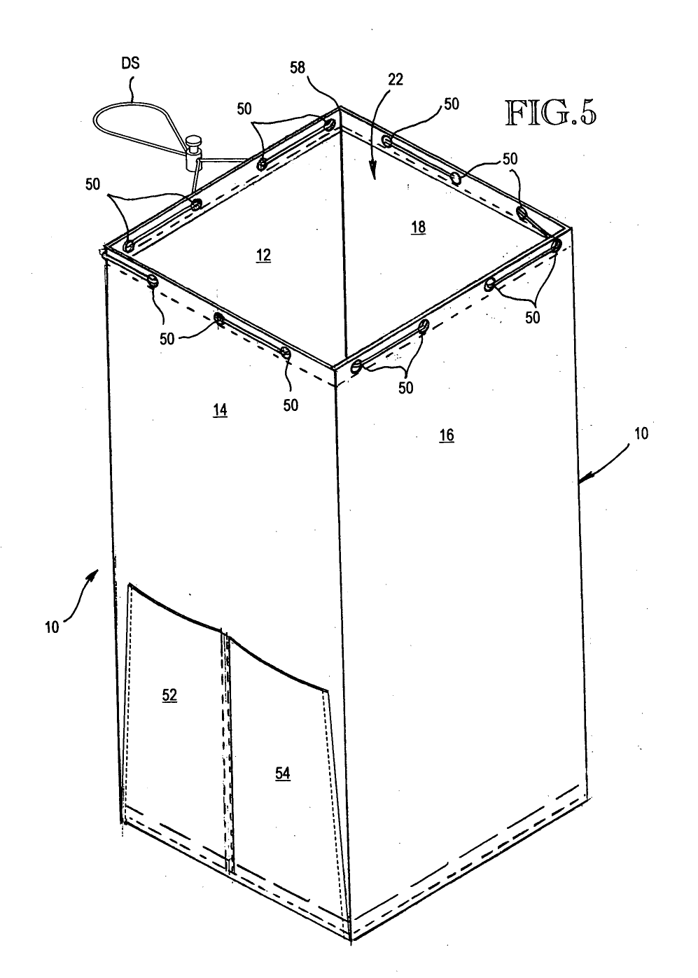

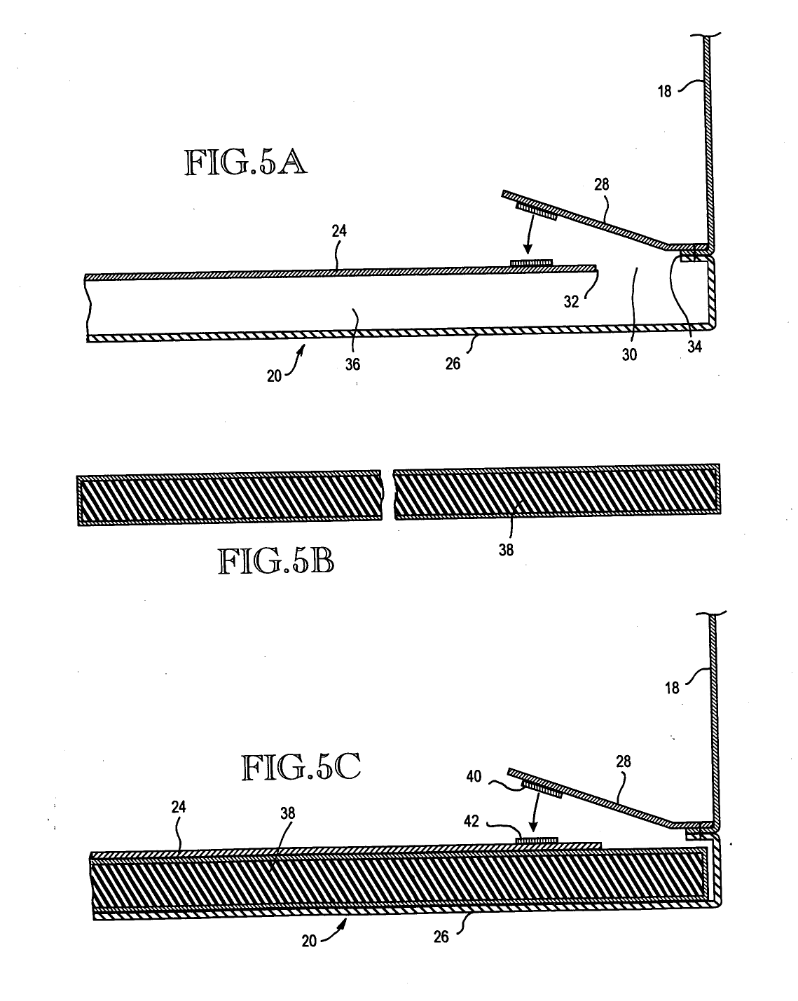

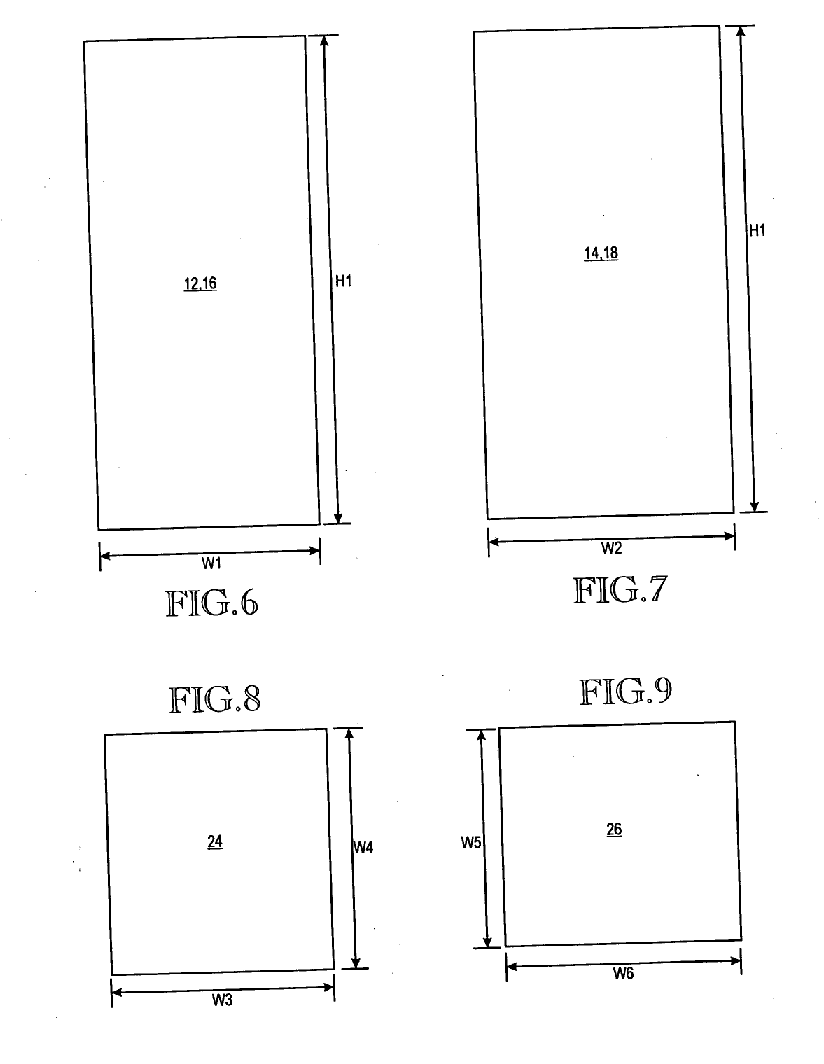

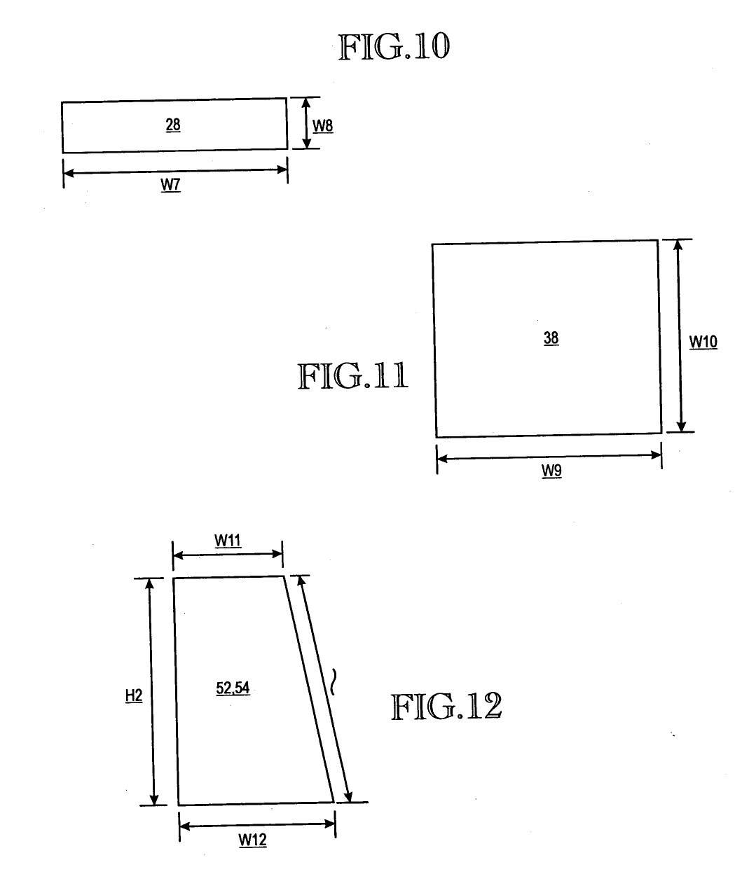

The bag 10 has four sides 12, 14, 16, 18 (FIG. 5), a bottom 20 (FIGS. 5A and 5C) and an open top 22. FIGS. 6-12 are flat views of fabric panels that are used to form the several parts of the bag 10. Sides 14, 18 may be wider than sides 12, 16. All four sides are preferably the same height h. By way of example, the height h may be about 43 inches. Width w1 may be 16 inches. Width w2 may be 21 inches. The lower portion 26 of the bottom 20 may have a width w3 of 19 inches and a width w4 of 21 inches. The upper portion 26 of bottom 20 may have a width w5 of 19 inches and width w6 of 20 inches. The upper portion of the bottom 20 includes a second part 28 that may have a width w7 of 19 inches and a width w8 of 4½ inches.

FIGS. 5A and 5C show how the members 24, 26, and 28 are connected to each other and to the side panels, with side panel 18 being shown by way of example. Edge portions of the panels are overlapped and are stitched together at the overlap. Panel 28 forms a flap that overlaps an edge portion of panel 24. A space 30 is defined between the edge 32 of panel 24 and the edges 34. Panel 24 is spaced above panel 26, creating a chamber 36 in which a pad 38 is received. Pad 38 has a width w9 which may be 19 inches and a width w10 which may be 17 inches. FIG. 5B shows the pad 38 by itself. FIG. 5C shows the pad 38 inside of the space 36, between panels 24, 28 at the top and panel 26 at the bottom. Hook and eye fasteners 40, 42 may be used for detachably connecting the inner edge portion of panel 28 to an adjacent edge portion of panel 38. A typical and well-known hook and eye fastener is sold under the brand name Velcro®. Of course, other fasteners can be used in place of the hook and eye fasteners.

The flap 28 shown in FIGS. 5A and 5C extends the full width of side 18. Flap 28 can be moved up against side wall 18 and bottom panel 24 may be lifted for the purpose of making the opening large 30 enough to receive the foam plastic pad 38. Foam plastic pad 38 may be a polyester foam, for example, covered with a thin plastic layer, providing it with washable surfaces. The foam plastic pad 38 is placed in the chamber 36 and then the flap 28 is closed, bringing the hook and eye fastener elements 40, 42 into engaging contact with each other. One of 40, 42 is the “hook” component and the other is the “eye” component. The elements 40, 42 may be continuous strips that extend across the width of the bag or they may be a plurality of short strips positioned along straight lines across the bag members 24, 28. When the flap 28 is closed, the foam plastic pad gives the bottom form and some stiffness. Referring to FIG. 5, a person can grasp the upper end of the bag 10 and lift the bag up. The bottom of the bag will have a substantially square shape and will be substantially flat.

The bag panels 12, 14, 16, 18, 24, 26, 28 may be made from the type of nylon that is used for making backpacks. All of these panels are soft and supple. However, the material is strong and rugged. It is also water-resistant and machine washable. The foam plastic pad 38 is removed first and then the bag 10 is placed into a washing machine and washed.

Preferably, a heavier gauge fabric is used for making the bottom panel 26. Preferably, all of the panels 12, 14, 16, 18, 24, 26, 28 are given a water-resistant coating such that when wet they tend to shed the water.

It is desirable that the bottom of the bag 10 have a square shape and it is also desirable that the upper portion of the bag be capable of being pulled together around the upper portion of the folded frame of the golf cart. The upper end of the bag is constructed so that it can be drawn together to close the opening 22. By way of example, a plurality of openings may be formed in the upper perimeter of the bag 10 and such openings may be reinforced by grommets 50. A drawstring DS is woven through the grommets 50 and is used for gathering together the material between the grommets 50 so as to close the top of the bag where it extends above the folded golf cart.

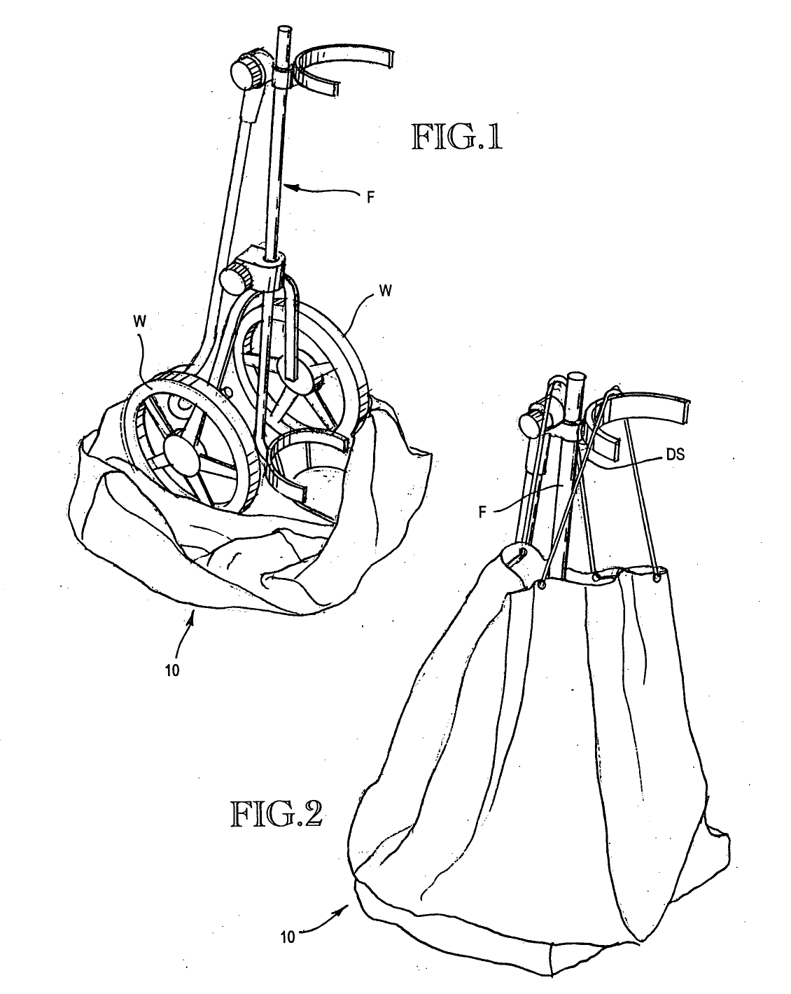

Referring to FIG. 1, the side wall of the bag, formed by the panels 12, 14, 16, 18 will collapse into a ring that surrounds the bottom 26. The center of the collapsed side wall is open, exposing the bottom 26. The wheels W at the lower end of a folded golf cart can be easily set down on the bottom 26. Then, the side wall 12, 14, 16, 18 can be raised upwardly along the golf cart frame F (FIG. 2). When the top of the bag 10 is above the top of the golf cart frame F, the drawstring DS is pulled upon to close the top of the bag 10. Pulling on the drawstring DS moves the grommets 50 close together and pleats the fabric in the regions between the grommets 50. The pleats extend downwardly and dissipate as the side walls approach the bottom.

It is not necessary to provide the bag 10 with a handle. When the upper portion of the bag is collapsed around the golf cart frame F, a person can grasp the upper portion of the bag and the golf cart frame F in the bag for the purpose of picking up the bag and golf cart for carrying them and moving them into a storage space, such as the trunk of a care, for example.

Preferably, the bag 10 is made from more than one color. For example, panels 14, 18, 24, 26, 28 may be made from black backpack nylon. One of panels 12, 16 may be black and the other may be gray, lavender, raspberry, red, blue, yellow, turquoise, etc.

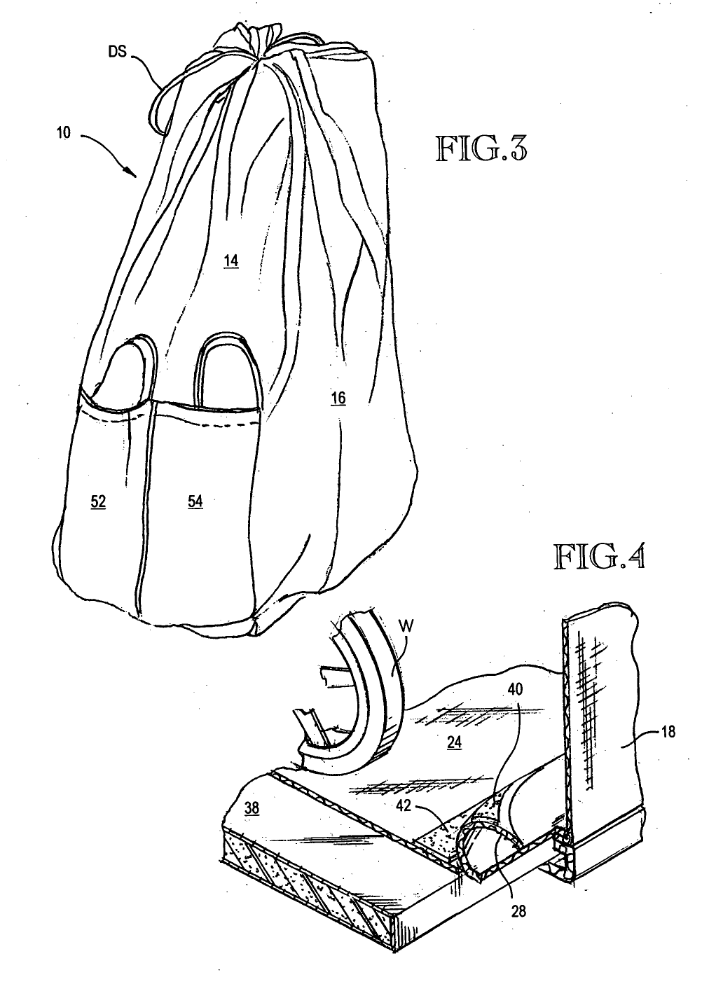

An option is to provide the bag 10 with shoe pockets 52, 54, made from flat panels 52, 54 shown by FIG. 12. Height h2 may be 20 inches. Width w11 may be 9½ inches. Width w12 may be 13 inches. Length l may be 20 inches. Again, soft nylon is used for the members 52, 54. They may be made the same color as side wall 14 or may be made from a different color fabric. The lower ends of the panels 52, 54 may be placed below the end of panel 14 and stitched to panel 14 and panels 24, 26. The vertical edges of the panels 52, may be stitched to the panel 14. The upper ends of the panels 52, 54 are not attached. This forms open tops into the pockets that are formed by and between the panels 52, 54 and the panel 14. FIG. 3 shows these pockets being used to hold a pair of golf shoes.

The illustrated embodiment is only an example of the present invention and, therefore, is non-limitive. It is to be understood that many changes in the particular structure, materials and features of the invention may be made without departing from the spirit and scope of the invention. Therefore, it is my intention that my patent rights not be limited by the particular embodiment that is illustrated and described herein, but rather is to be determined by the following claims, interpreted according to excepted doctrines of claim interpretation including use of the doctrine of equivalents.

What is claimed is:

1. A bag for receiving and holding a folded golf cart, said folded golf cart having wheels moved together at its bottom and a collapsed frame extending upwardly from the wheels to a top, said bag comprising:
a bottom and a sidewall, said bottom having a periphery;
said sidewall having a lower edge that is connected to and extends around the periphery of the bottom;
said sidewall extending upwardly from the bottom to an open top that is adapted to be above the top of the collapsed frame of a folded golf cart that is in the bag;
said sidewall being a supple fabric member;
said bottom having a supple fabric upper portion and a supple fabric lower portion which meet and are connected together at the periphery of the bottom;
a foam plastic insert in the bottom between the upper and lower fabric portions of the bottom, giving the bottom a form and some stiffness;
a tie gathering the bag together and closing the bag above the top of the frame;
pleats in an upper portion of the supple sidewall; and
wherein for lifting and carrying the folded golf cart and the bag the sidewall of the bag and the collapsed frame can be grasped together where the bag sidewall surrounds the collapsed frame.

2. The bag of claim 1, wherein the supple fabric upper portion of the bottom includes a first part and a second part, and said first part overlapping the second part where they meet, forming a flapped opening through which the foam plastic insert can be inserted and removed.

3. The bag of claim 2, comprising hook and eye fasteners in the region of the overlap for connecting the two parts of the supple fabric upper portion of the bottom together when the foam plastic insert is between the upper and lower fabric portions of the bottom.

4. The bag of claim 1, wherein the supple fabric sidewall and the supple fabric upper and lower portions of the bottom are water resistant and machine washable.

5. The bag of claim 1, wherein the supple fabric sidewall and the supple fabric upper and lower portions of the bottom are constructed from nylon.

6. The bag of claim 5, wherein the supple fabric upper portion of the bottom includes a first part and a second part, and said first part overlapping the second part where they meet, forming a flapped opening through which the foam plastic insert can be inserted and removed.

7. The bag of claim 6, comprising hook and eye fasteners in the region of the overlap for connecting the two parts of the supple fabric upper portion of the bottom together when the foam plastic insert is between the upper and lower fabric portions of the bottom.

8. The bag of claim 1, wherein the sidewall includes a ring of spaced apart openings extending around an upper portion of the sidewall and the tie is an elongated flexible member that weaves in and out through said openings and has end portions that can be pulled upon to gather the bag together about the top of the frame and then be connected together to hold the bag gathered.

9. The bag of claim 1 wherein the sidewall is formed from at least two side members that meet and are connected together along vertical seam lines.

10. The bag of claim 9, wherein the sidewall includes a portion disposed between two vertical seam lines that is a first color and the rest of the side wall is a different color than the first color.

11. The bag of claim 10, wherein the supple fabric upper portion of the bottom includes a first part and a second part, said first part overlapping the second part where they meet, forming a flapped opening through which the foam plastic insert can be inserted and removed.

12. The bag of claim 11, comprising hook and eye fasteners in the region of the overlap for connecting the two parts of the supple fabric upper portion of the bottom together when the foam plastic insert is between the upper and lower fabric portions of the bottom.

13. The bag of claim 12, wherein the foam plastic insert is a polyester foam member.

14. The bag of claim 1, wherein the foam plastic insert is a polyester foam member.
